(19) United States
(12) Patent Application Publication
(10) Pub. No.: US 2003/0083985 A1
(43) Pub. Date: May 1, 2003

(54) Credit card transaction security management system and method

(76) Inventors: Fu-Tien Chen, Taipei (TW); Chin-Huan Chu, Taipei (TW)

Correspondence Address: Joseph A. Mahoney, Mayer, Brown & Platt, P.O. Box 2828, Chicago, IL, 60690, US

(21) Appl. No.: 09/999,019

(22) Filed: Nov. 1, 2001

(51) Int. Cl. G06F 17/60

(52) U.S. Cl. 705/39

(57) ABSTRACT

The present invention provides a transaction secure management system and method for identifying assertion of a transaction directed to a financial account. The invention system comprises at least one storage module, an analysis module, a communication module, and a determining module. The storage module is for storing historical account data associated with the financial account, a communication number associated with the legitimate account owner, and at least one predetermined limit. The analysis module is for receiving data associated with the transaction, accessing from the first storage module the historical account data associated with the financial account, and from the second storage module the least one predetermined limit, analyzing the transaction by the data associated with the transaction and the historical account data associated with the financial account, and checking whether the analyzed result goes beyond one of the predetermined limits. The communication module is for accessing the communication number associated with the owner. When the analyzed result of the analysis module goes beyond any one of the predetermined limits, the communication module transmits inquiry information to contact the owner based on the communication number. The determining module is for receiving a response responsive to the inquiry information through the communication module, selectively identifying, and in accordance with the response, that the transaction is asserted by the owner.

### FIELD OF THE INVENTION

The present invention relates to a transaction security management system and method for a financial account, e.g., a credit card account, a debit card account, a smart card account, a chip card account, a digital transaction card account or an account for another payment instrument. More particularly, the invention relates to a system and method for identifying assertion of a transaction directed to a financial account, and identifying if the assertion is asserted by a person who owns the associated financial account.

### BACKGROUND OF THE INVENTION

As the information technology improving, the payment instruments have been evolved from traditional bills and coins into checks, credit cards, electronic cash, electronic checks, etc. Those all reveal quick evolvement of payment instruments. However, no matter what type of payment instruments all encounter the challenge of transaction frauds.

Especially, the convenience of making purchases through the use of a credit cards have made credit card transactions more popular now than at any other time in history. Unfortunately, credit-card fraud is an increasingly large problem. Stolen or falsified credit cards are frequently used to conclude fraudulent credit card transactions. As a result, credit card frauds increase the cost of providing the convenience of credit card transactions to cardholders and merchants.

Therefore, in the universe, a large number of governments and financial institutions have taken many efforts to reduce the frequency of credit card frauds and to develop many technologies for preventing from credit card frauds. There are a number of current technologies trying to solve the fraud problems. For example, SSL (Secure Sockets Layer) and SET (Secure Electric Transaction) are two famous security protocols applied to the transactions over Internet. Besides, the anti-fraud logo “laser dove” on the corner of the credit card, the fraud detection system of issuing banks, the signatures of cardholders, and the authorization method have been keeping improved to try to prevent from credit card frauds.

In addition, U.S. Pat. No. 6,254,000 disclosed a method for identifying and notifying credit card issuing banks of an increased risk of credit card fraud by providing an early warning system. U.S. Pat. No. 6,208,978 disclosed a method for issuing a security deposit guarantee. U.S. Pat. No. 6,129,272 disclosed a method for realizing payments through computers electronically.

However, the aforementioned methods can just lower the risk of frauds, but cannot eliminate the frauds. Accordingly, an objective of the present invention is to provide a transaction secure management system and method for identifying assertion of a transaction directed to a financial account. Thereby, the invention provides the cardholder with a secure system to prevent credit card fraud. The present invention is a user-driven transaction secure management system which is able to lower the loss of fraud transactions. Moreover, due to the huge information processing systems of financial institutions, the prior-art secure methods applied to the huge systems lead to not only lower the convenience of transaction but also increase the cost of financial institutions. As a result, although there has been lots of methods and systems for preventing fraud of payment instruments, very few of them are practically effective.

Therefore, another objective of the present invention is utilizing the communication technology, like short massage sending technology, to connect transaction secure mechanism with financial account holder properly. The prior art of short massage sending technology can be referred to U.S. Pat. No. 6,151,507.

### SUMMARY OF INVENTION

An objective of the present invention is to provide a transaction secure management system and method for identifying assertion of a transaction directed to a financial account. Thus, the present invention provides a user-driven transaction secure management system and method which can lower the loss of fraud transactions.

Another objective of the present invention is utilizing the communication technology, like short massage sending technology, to connect transaction secure mechanism with financial account holder properly. Thus, the present invention provides a low cost transaction secure management system and method.

In a preferred embodiment, the present invention provides a transaction secure management system for identifying assertion of a transaction directed to a financial account, and identifying if the assertion is asserted by a person who owns the associated financial account. The system comprising a first storage module, a second storage module, a analysis module, a communication module, and a determining module. The first storage module stores historical account data associated with the financial account and a communication number associated with the person. The second storage module stores at least one predetermined limit. The analysis module receives data associated with the transaction, accessing from the first storage module the historical account data associated with the financial account, and accessing from the second storage module one of the aforementioned predetermined limits, analyzing the transaction by the data associated with the transaction and the historical account data associated with the financial account, and checking whether the analyzed result goes beyond any one of the aforementioned predetermined limits. When the analyzed result of the analysis module goes beyond any one of the predetermined limits, the communication module accesses the communication number associated with the person, and transmits inquiry information to contact the person based on the communication number. The determining module receives a response responsive to the inquiry information through the communication module, and based the response, selectively identifies if the transaction is asserted by the person.

According to the information processing of the present transaction secure management system, it comprises the following steps. First, receive data associated with the transaction. Access from the first storage module the historical account data associated with the financial account, and from the second storage module the stored predetermined limits. Analyze the transaction by the data associated with the transaction and the historical account data associated with the financial account. Check whether the analyzed result goes beyond one of the aforementioned predetermined limits. If the answer to the analyzed result is “YES”, access the communication number associated with the person, transmit inquiry information to contact the person based on the communication number, receive a response responsive to the inquiry information through the communication module, and then selectively identifying if the transaction is asserted by the person based on the response.

The advantage and spirit of the invention may be understood by the following recitations together with the appended drawings.

### BRIEF DESCRIPTION OF THE APPENDED DRAWINGS

FIG. 1 is a. schematic diagram of the transaction secure management system 40 according to the preferred embodiment of the present invention.

FIG. 2 is a. information processing flow chart of the transaction secure management system 40 according to the preferred embodiment of the present invention.

### DETAILED DESCRIPTION OF THE INVENTION

The present invention provides a transaction secure management system and method utilizing the prosperous communication technology in operation, like short massage sending technology, to connect transaction secure mechanism with financial account holder properly for identifying assertion of a transaction directed to a financial account. Thus, when the associated financial account is under the circumstances of being misused, stolen, misplaced or counterfeited, the present invention provides an user-driven transaction secure management system and method which can lower the loss of fraud transactions and provides a relative low cost transaction secure management system and method without extra cost of the information process apparatus. In the following, the characteristic, advantage, and the application field of the present invention will be illustrated with the preferred embodiment of present invention.

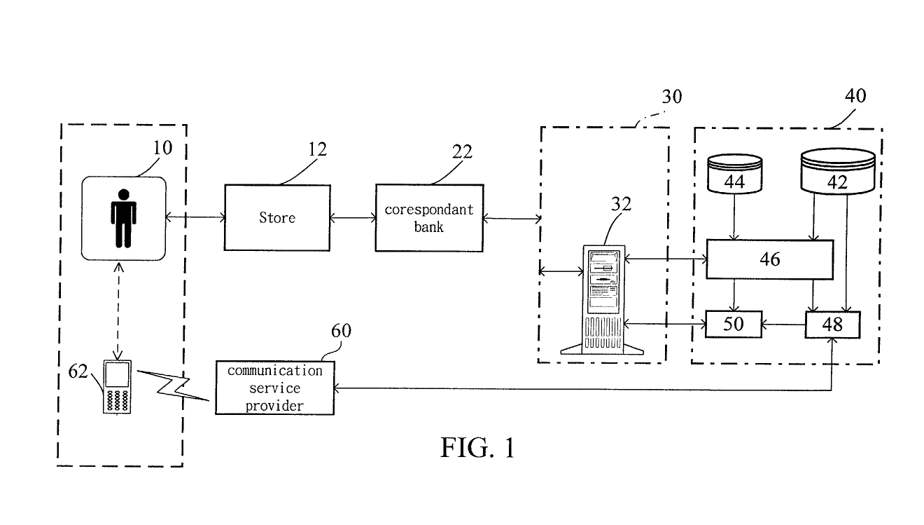

Referring to FIG. 1, FIG. 1 is a schematic diagram of the present transaction security management system 40 by means of plastic monetary, such as credit card. The same as the usual credit card transaction secure management system, when a card holder 10 uses a credit card to conduct a transaction, there would be a financial account provided by a correspondent bank 22 associated with the issued credit card. The issuing bank and the correspondent bank can be the same bank or not. The transaction secure management system 40 in FIG. 1 illustrates the issuing bank 30 and the correspondent bank 22 as two independent banks.

Thus, when the card holder 10 conducts a transaction in a store 12 which cooperates with the issuing bank 30, the transaction then is transferred from Credit Card Authorization Terminal, CAT, of the store 12 (not shown in FIG. 1) to the correspondent bank 22 via network. At the mean time, the correspondent bank 22 connects to the issuing bank 30 asking for authorization of the transaction. The transaction secure management system 40 according to the first preferred embodiment of the present invention can be merge into the information processing system 32 of the issuing bank 30, or can form its own information processing system independent of the issuing bank 30 and connect to the information processing system 32 of the issuing bank 30. The transaction secure management system 40 in FIG. 1 illustrates the system 40 as an independent system from the information processing system of the issuing bank 30.

It has to be noticed and emphasized that the so called “card hoder 10” is not necessarily the legitimate card holder of the credit card, and can also be a fraud card holder which get the credit card by illegitimate means, such as illegal possessing, counterfeiting, etc. However, there should be only one financial account correspondent to the credit card, and the account cannot be forged. Thus, it is the key idea of the present invention to utilize the transaction secure management system 40 to identify whether the present cardholder 10 to conduct and assert the specific transaction is the same person as the real cardholder of the associated financial account.

As shown in FIG. 1, the transaction secure management system 40 according to the preferred embodiment of the present invention comprises a first storage module 42, a second storage module 44, an analysis module 46, a communication module 48, and a determining module 50.

The first storage module 42 is utilized for storing historical account data associated with the financial account and a communication number associated with the person. The second storage module 44 is utilized for storing at least one predetermined limit. In one embodiment, the predetermined limit can be a limit regarding to the given largest amount of money per transaction. For example, the predetermined limit is 20000 NT dollars per transaction.

In another embodiment, the predetermined limit can be a limit regarding transaction times during a predetermined period. For example, predetermined limit is 5 times a day.

In another embodiment, the predetermined limit can be a limit regarding transaction area. For example, predetermined limit is that the transaction must be conducted within a specific area, e.g., Taipei or Taiwan. This can be done by identifying the store ID number while the store 12 requesting authorization for the transaction, or by the area code of the phone number of the store 12.

In another embodiment, the predetermined limit can be a limit regarding the item type of the purchased goods. For example, the credit card can only be used for buying a flight ticket. This can be done by identifying the item type numbers of the purchased goods or products.

In fact, all the aforementioned predetermined limits can be options available to the legitimate cardholders while they apply for the credit card, or even owning the credit card it can still be done via all kinds of automatic financial channels provided by financial institutions. For example, the financial institutions can set these predetermined limits on request by the legitimate cardholder, or the financial institutions (including the correspondent banks or the issuing banks) can set these predetermined limits according to the analysis result of transaction historical data.

Referring to FIG. 1. The analysis module 46 is connected with the information processing system 32 of the issuing bank 30, the first storage module 42, and the second storage module 44. The analysis module 46 is utilized for receiving data associated with the transaction, accessing from the first storage module 42 the historical account data associated with the financial account, and accessing from the second storage module 44 the predetermined limits to analyze the transaction by the data associated with the transaction and the historical account data associated with the financial account, and checking whether the analyzed result goes beyond any one of the predetermined limits. When the analyzed result of the analysis module 46 goes beyond one of the predetermined limits, the communication module 48 connected with the analysis module 46 is then activated to access the communication number associated with the person form the first storage module 42, and transmit inquiry information to contact the person based on the communication number.

Referring to FIG. 1. The financial account holder possesses a communication device 62, such as a mobile phone or a personal digital assistant (PDA), preferably the portable devices. The communication device is consequently served by a communication service provider 60, such as telecommunication service providers or an Internet service providers. All the inquiry information transmitted to contact the financial account holder is transformed in the communication module 48 into the proper format as the communication service provider 60 required, then transmits to the communication device 62 via the communication service provider 60. In practice, the communication service provider 60 communicates with the communication device 62 via wireless communications.

Thus, the legitimate financial account owner is able to receive the inquiry information via the communication device 62, and transmits a response responsive to the inquiry information to the determining module 50 properly via the communication service provider 60a and the communication module 48. The determining module 50 receives the response responsive to the inquiry information and selectively identifies in accordance with that response, that the transaction is asserted by the legitimate financial account owner. In another word, when the card holder 10 is the legitimate financial account owner, the financial account owner would response positive, and then the determining module 50 confirms the transaction is asserted by the legitimate financial account owner. When the card holder 10 is not the legitimate financial account owner, the financial account owner would response negative, and then the determining module 50 confirms the transaction is not asserted by the legitimate financial account owner and the transaction fails and stops to prevent further risk or damage. The determining module 50 of the present invention can also be design as when the response is wrong or when the determining module 50 does not receive the response within a predetermined time interval, and then it would confirm the transaction is not asserted by the legitimate financial account owner.

Furthermore, when the analyzed result of the analysis module 46 doesn't go beyond any one of the predetermined limits, the communication module 48 connected to the analysis module 46 is then activated to confirm that the transaction is asserted by the legitimate financial account owner. The determining module 50 further transmits the confirmation result to the information processing system 32 of the issuing bank 30. The issuing bank 30 and the correspondent bank 22 then further process the transaction, for example, terminating the transaction or temporarily closing the financial account in order to lower the loss of credit card frauds, etc.

In one embodiment, the inquiry information is transmitted in a form of short message. In practice, transmitting in a form of short message can be combined with the “query technique” of issuing bank 32. For example, the query can be done by asking about the private information of the legitimate financial account owner, such as birth date or ID numbers. In another embodiment, the inquiry information is transmitted in a form of e-mail.

In another preferred embodiment, the first storage module 42 and the second storage module 44 are integrated as a single storage module. In another embodiment, the aforementioned storage modules are all parts of the information processing system 32 of the issuing bank 30. In another embodiment, the aforementioned storage modules can be parts of the information processing system 32 of the correspondent bank 22.

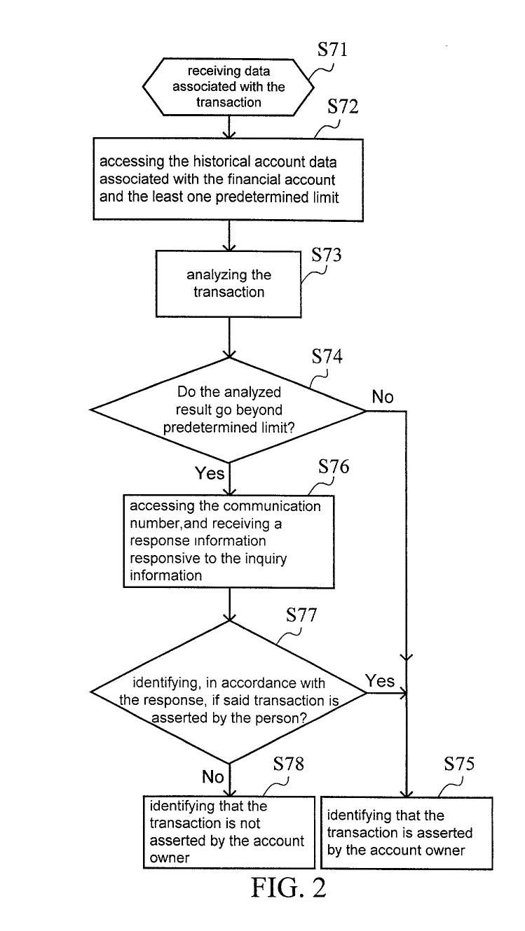

Referring to FIG. 2. FIG. 2 is an information processing flow chart of the transaction secure management system 40 according to the preferred embodiment of the present invention. The flow chart of the preferred embodiment is described in the following. First, execute step S71 by receiving data associated with the transaction. Then go on to step S72 by accessing from the first storage module the historical account data associated with the financial account, and accessing from the second storage module at least one of the aforementioned predetermined limit. Then execute step S73 to analyze the transaction by the data associated with the transaction and the historical account data associated with the financial account. And continue to execute step S74 by checking whether the analyzed result in step S73 goes beyond any one of the predetermined limits. If “NO” in step S74, then go on to step S75 to identify that the assertion of the transaction is asserted by the legitimate financial account owner. If “YES” in step S74, then go on to step S76 by accessing the communication number associated with the account owner from the first storage module, transmitting inquiry information to contact the account owner based on the communication number, and receiving a response responsive to the inquiry information via the communication module. In step S77, based on the response, identifying whether the assertion of the transaction is asserted by the legitimate financial account owner or not. If “YES” in step S77, then go back to step S75 to confirm that the transaction is asserted by the legitimate financial account owner. If “NO” in step S77, then go on to step S78 to identify that the assertion of the transaction is not asserted by the legitimate financial account owner.

The transaction secure management method of the present invention is able to examine each transaction to detect any transaction abnormal situations. When detect frauds, the method then terminates the transaction or temporarily closes the financial account in order to lower the loss of credit card frauds. Especially, the present invention utilizes the communication technology to connect transaction secure mechanism with financial account owner properly, in order to let the financial account owners control their own payment instruments. Thus, the present invention not only can lower the risk of payment instrument fraud but also can increase the trust relationship between payment instrument owners and financial institutions. Obviously, the present invention mainly focuses on analyzing the account history, and doesn't need to substantially modify the existing information processing system of financial institutions. Thus, the present invention provides a low cost transaction secure management system and method.

While the invention has been described in several preferred embodiments, it is understood that the words which have been used are words of description rather than words of limitation and that changes within the purview of the appended claims may be made without departing from the scope and spirit of the invention in its broader aspect.

What is claimed is:

1. A data processing apparatus for identifying assertion of a transaction directed to a financial account, said financial account being held by a person, said data processing apparatus comprising:
a first storage module for storing historical account data associated with said financial account and a communication number associated with said person;
a second storage module for storing at least one predetermined limit;
an analysis module for
receiving data associated with said transaction,
accessing from said first storage module the historical account data associated with said financial account, and from said second storage module the least one predetermined limit,
analyzing said transaction by the data associated with said transaction and the historical account data associated with said financial account, and
checking whether the analyzed result goes beyond one of the at least one predetermined limit;
a communication module for
accessing the communication number associated with said person when the analyzed result of the analysis module goes beyond one of the at least one predetermined limit, and
transmitting inquiry information to contact said person based on the communication number, and
a determining module for
receiving a response responsive to the inquiry information through said communication module, and
selectively identifying, according to said response, that said transaction is asserted by said person.

2. The data processing apparatus of claim 1, wherein the financial account is a credit card account.

3. The data processing apparatus of claim 2, wherein the least one predetermined limit comprises a limit regarding amount of money per transaction.

4. The data processing apparatus of claim 2, wherein the least one predetermined limit comprises a limit regarding transaction frequency during a predetermined period.

5. The data processing apparatus of claim 2, wherein the least one predetermined limit comprises a limit regarding transaction area.

6. The data processing apparatus of claim 2, wherein the inquiry information is transmitted in a form of short message.

7. A transaction security management system for identifying assertion of a transaction directed to a financial account, said financial account being held by a person, said person having a communication device, said system comprising:
a storage module for storing historical account data associated with said financial account, a communication number associated with said communication device and at least one predetermined limit;
an analysis module for
receiving data associated with said transaction,
accessing from said storage module the historical account data associated with said financial account, and from said storage module the least one predetermined limit,
analyzing said transaction by the data associated with said transaction and the historical account data associated with said financial account, and
checking whether the analyzed result goes beyond one of the at least one predetermined limit;
a communication module, for
accessing the communication number associated with said person when the analyzed result of the analysis module goes beyond one of the at least one predetermined limit, and
transmitting inquiry information to said communication to contact said person based on the communication number, and
a determining module, for
receiving a response responsive to the inquiry information through said communication module,
selectively identifying, according to said response, that said transaction is asserted by said person.

8. The transaction security management system of claim 7, wherein the financial account is a credit card account.

9. The data processing apparatus of claim 8, wherein the inquiry information is transmitted in a form of short message.

10. The data processing apparatus of claim 9, wherein said communication device is a mobile phone.

11. The data processing apparatus of claim 9, wherein said communication device is a personal digital assistant.

12. The transaction security management system of claim 10, wherein the least one predetermined limit comprises a limit regarding amount of money per transaction.

13. The transaction security management system of claim 10, wherein the least one predetermined limit comprises a limit regarding transaction frequency during a predetermined period.

14. The transaction security management system of claim 10, wherein the least one predetermined limit comprises a limit regarding transaction area.

15. A data processing method for identifying assertion of a transaction directed to a financial account, said financial account being held by a person, a first storage module storing historical account data associated with said financial account and a communication number associated with said person, a second storage module storing at least one predetermined limit, said method comprising the steps of:
(a) receiving data associated with said transaction;
(b) accessing from said first storage module the historical account data associated with said financial account, and from said second storage module the least one predetermined limit;
(c) analyzing said transaction by the data associated with said transaction and the historical account data associated with said financial account;
(d) checking whether the analyzed result goes beyond one of the at least one predetermined limit;
(f) if YES in step (d),
accessing the communication number associated with said person,
transmitting inquiry information to contact said person based on the communication number,
receiving a response responsive to the inquiry information through said communication module,
selectively identifying, according to said response, that said transaction is asserted by said person.

16. The data processing method of claim 15, further comprising the step of:
(g) if NO in step (d), identifying that said transaction is asserted by said person.

17. The data processing method of claim 16, wherein the financial account is a credit card account.

18. The data processing method of claim 17, wherein the least one predetermined limit comprises a limit regarding amount of money per transaction.

19. The data processing method of claim 17, wherein the least one predetermined limit comprises a limit regarding transaction frequency during a predetermined period.

20. The data processing method of claim 17, wherein the least one predetermined limit comprises a limit regarding transaction area.

21. The data processing method of claim 17, wherein the inquiry information is transmitted in a form of short message.

22. A transaction security management method for identifying assertion of a transaction directed to a financial account, said financial account being held by a person, said person having a communication device, a storage module storing historical account data associated with said financial account, a communication number associated with said communication device and at least one predetermined limit, said method comprising the steps of:
(a) receiving data associated with said transaction;
(b) accessing from said storage module the historical account data associated with said financial account and the least one predetermined limit;
(c) analyzing said transaction by the data associated with said transaction and the historical account data associated with said financial account;
(d) checking whether the analyzed result goes beyond one of the at least one predetermined limit;
(f) if YES in step (d),
accessing the communication number associated with said person,
transmitting inquiry information to said communication device to contact said person based on the communication number,
receiving a response information from said person responsive to the inquiry information through said communication module,
selectively identifying, according to said response, that said transaction is asserted by said person.

23. The transaction security management method of claim 15, further comprising the step of:
(g) if NO in step (d), identifying that said transaction is asserted by said person.

24. The transaction security management method of claim 23, wherein the financial account is a credit card account.

25. The transaction security management method of claim 24, wherein the inquiry information is transmitted in a form of short message.

26. The transaction security management method of claim 25, wherein said communication device is a mobile phone.

27. The transaction security management method of claim 25, wherein said communication device is personal digital assistant.

28. The transaction security management method of claim 26, wherein the least one predetermined limit comprises a limit regarding amount of money per transaction.

29. The transaction security management method of claim 26, wherein the least one predetermined limit comprises a limit regarding transaction frequency during a predetermined period.

30. The transaction security management method of claim 26, wherein the least one predetermined limit comprises a limit regarding transaction area.
